(19) United States
(12) Patent Application Publication
(10) Pub. No.: US 2015/0055259 A1
(43) Pub. Date: Feb. 26, 2015

(54) Whole-Chip Esd Protection Circuit and Esd Protection Method

(71) Applicant: Montage Technology (Shanghai) Co. Ltd., Shanghai (CN)

(72) Inventors: Xiangning Cao, Shanghai (CN); Yong Wang, Shanghai (CN)

(73) Assignee: Montage Technology (Shanghai) Co. Ltd., Shanghai (CN)

(21) Appl. No.: 14/164,196

(22) Filed: Jan. 25, 2014

(30) Foreign Application Priority Data
Aug. 26, 2013 (CN) 201310376740.0

(51) Int. Cl. H02H 9/04

(52) U.S. Cl. CPC H02H 9/049
USPC 361/56

(57) ABSTRACT

A whole-chip Electrostatic Discharge (ESD) protection circuit and protection method are provided. The whole-chip ESD protection circuit comprises: input/output (I/O) units located between a power line and a grounding wire; a power clamp circuit located between the power line and the grounding wire and connected to the I/O units, any power clamp circuit being shared by multiple I/O units; and an ESD trigger circuit located between the power line and the grounding wire. The ESD trigger circuit generates an ESD trigger signal when an ESD events occurs and transmits the ESD trigger signal to the power clamp circuit and each I/O unit so that the power clamp circuit and each I/O unit form a current discharge path from the power line to the grounding wire respectively. Compared with the prior art, the present invention fully utilizes an existing driving transistor in the I/O unit to realize efficient whole-chip ESD protection and avoids adding too many power clamp circuits in the whole chip with regard to ESD, thereby reducing the overall size of the chip and lowering the cost.

### CROSS REFERENCE TO RELATED PATENT APPLICATION

The present application claims the priority of the Chinese patent application No. 201310376740.0 filed on Aug. 26, 2013, which application is incorporated herein by reference.

### BACKGROUND OF THE PRESENT INVENTION

1. Field of Invention The present invention relates to an Electrostatic Discharge (ESD) protection technology, and particularly to a whole-chip ESD protection circuit and ESD protection method.

2. Description of Related Arts

With rapid development of intelligent power process and high-power semiconductor devices, electronic products is becoming increasingly miniaturized and portable, thus increasing the application of power electronic devices. ESD (Electrostatic Discharge) has become one of the most critical reliability issues in integrated circuits, which leads to failure or damage to power electronic device and the integrated circuit (IC) function thereof because static electricity is often generated during manufacturing, packaging, testing, and use procedures of devices. For example, ESD events may be caused by accidental contact between two electrically charged objects and the following buildup of discharge path, thus resulting in device failure or even permanent damage. Therefore, the ESD protection issue has always been one of the important issues in IC design field. However, the continuous increasing IC scale and the introduction of new device concepts have brought in many new ESD challenges.

At present, a current approach for ESD protection circuit design is to continuously increase the size of an ESD protection circuit, especially the size of a power clamp circuit between a power line (VDD) and the grounding wire, and meanwhile to add a great number of the power clamp units in the whole-chip layout, so as to improve the uniformity of the ESD current discharge. FIG. 1 shows an embodiment of previous ESD protection circuit in the prior art, a distributed power clamp circuit is employed in this design. As shown in FIG. 1, M1 represents a power clamp circuit used for ESD protection. When ESD events occurs, a specific trigger circuit is capable of generating a trigger signal so as to turn on a corresponding power clamp circuit M1, thereby discharging an ESD current. In order to improve the uniformity of the current discharge at different positions within the chip, power clamp circuits are uniformly distributed in input/output (I/O) units, namely, each I/O unit is configured with a power clamp circuit.

According to the prior art shown in FIG. 1, each I/O unit requires to be configured with a power clamp circuit, and consequently, the overall size and the cost of the chip are unnecessarily and significantly increased.

### SUMMARY OF THE PRESENT INVENTION

For the above disadvantage in the prior art, the present invention provides a whole-chip ESD protection circuit and ESD protection method, so as to avoid size or cost increase caused by power clamps configured for each I/O unit in the prior art.

To solve the foregoing problem in the prior art, in one aspect, the present invention provides a whole-chip ESD protection circuit, comprising: I/O units located between a power line and a grounding wire; a power clamp circuit located between the power line and the grounding wire and connected to the I/O units, each power clamp circuit being shared by multiple I/O units; and an ESD trigger circuit located between the power line and the grounding wire, wherein the ESD trigger circuit generates an ESD trigger signal when an ESD events occurs and transmits the ESD trigger signal to the power clamp circuit and each I/O unit so that the power clamp circuit and each I/O unit respectively forms a current discharge path from power to ground.

Preferably, the ESD trigger circuit comprises: a resistor-capacitor circuit (RC circuit) connected in series between the power line and the grounding wire, wherein a first end of the capacitor C is connected to the power line, a second end of the capacitor C is connected to a first end of the resistor R, and a second end of the resistor R is connected to the grounding wire; a first NOT gate F1 and a second NOT gate F2 located between the power line and the grounding wire, wherein an input of the first NOT gate F1 is connected to the second end of the capacitor C and the first end of the resistor R, an output of the first NOT gate F1 is used for outputting a first trigger signal, an input of the second NOT gate F2 is connected to the output of the first NOT gate F1, and an output of the second NOT gate F2 is used for outputting a second trigger signal.

Preferably, the power clamp circuit comprises a PMOS transistor, wherein a gate of the PMOS transistor is connected to the output of the second NOT gate F2 in the ESD trigger circuit, a drain of the PMOS transistor is connected to the power line, and a source of the PMOS transistor is connected to the grounding wire.

Preferably, the I/O unit comprises: a first PMOS transistor MP1, a first NMOS transistor MN1, a positive current path protection circuit, a negative current path protection circuit, a first logic control cell, and a second logic control cell, wherein a gate of the first PMOS transistor MP1 is connected to the first logic control cell; a source of the first PMOS transistor MP1 is connected to the power line; a drain of the first PMOS transistor MP1 and a drain of the first NMOS transistor MN1 are jointly connected to an I/O pin; a gate of the first NMOS transistor MN1 is connected to the second logic control cell; a source of the first NMOS transistor MN1 is connected to the grounding wire; the first logic control cell is connected to the grounding wire as well as the output of the first NOT gate F1 and the output of the second NOT gate F2 in the ESD trigger circuit; and the second logic control cell is connected to the power line as well as the output of the first NOT gate F1 and the output of the second NOT gate F2 in the ESD trigger circuit.

Preferably, the first logic control cell comprises: a second NMOS transistor MN2, a third NMOS transistor MN3, and a third PMOS transistor MP3, wherein a gate of the second NMOS transistor MN2 is connected to a gate of the third PMOS transistor MP3; a source of the second NMOS transistor MN2 is connected to the grounding wire; a drain of the second NMOS transistor MN2 is connected to the gate of the first PMOS transistor MP1; a gate of the third NMOS transistor MN3 is connected to the output of the first NOT gate F1; a source of the third NMOS transistor MN3 is connected to a source of the third PMOS transistor MP3 as well as the gate of the first PMOS transistor MP1; a drain of the third NMOS transistor MN3 is connected to a drain of the third PMOS transistor MP3; and a gate of the third PMOS transistor MP3 is connected to the output of the second NOT gate F2. The second logic control cell comprises: a second PMOS transistor MP2, a fourth NMOS transistor MN4, and a fourth PMOS transistor MP4, wherein a gate of the second PMOS transistor MP2 is connected to a gate of the fourth NMOS transistor MN4; a source of the second PMOS transistor MP2 is connected to the power line; a drain of the second PMOS transistor MP2 is connected to the gate of the first NMOS transistor MN1; a gate of the fourth NMOS transistor MN4 is connected to the output of the first NOT gate F1; a source of the fourth NMOS transistor MN4 and the source of the fourth PMOS transistor MP4 are jointly connected to the gate of the first NMOS transistor MN1; a drain of the fourth NMOS transistor MN4 is connected to a drain of the fourth PMOS transistor MP4; and a gate of the fourth PMOS transistor MP4 is connected to the output of the second NOT gate F2.

Preferably, the positive current path protection circuit comprises a first diode D1, a cathode of the first diode D1 being connected to the power line, and an anode of the first diode D1 being connected to the I/O pin. The negative current path protection circuit comprises a second diode D2 cathode of the second diode D2 being connected to the I/O pin, and an anode of the second diode D2 being connected to the grounding wire.

Preferably, the ESD trigger circuit and the power clamp circuit are disposed in a power supply module or the ESD trigger circuit is disposed in a filler cell of the chip.

In another aspect, the present invention provides a whole-chip ESD protection method, comprising steps of: providing an ESD protection device between a power line and a grounding wire, wherein the ESD protection device comprises: I/O units located between a power line and a grounding wire; a power clamp circuit located between the power line and the grounding wire and connected to the I/O units, each power clamp circuit being shared by multiple I/O units; and an ESD trigger circuit located between the power line and the grounding wire; and

protecting the I/O unit from ESD damage, comprising steps of: the ESD trigger circuit generating an ESD trigger signal when an ESD events occurs and transmitting the ESD trigger signal to the power clamp circuit and each I/O unit so that the power clamp circuit and each I/O unit respectively forms a current discharge path from the power line to the grounding wire.

Preferably, the ESD trigger circuit comprises: a resistor-capacitor circuit (RC circuit) connected in series between the power line and the grounding wire, wherein a first end of the capacitor C is connected to the power line, a second end of the capacitor C is connected to a first end of the resistor R, and a second end of the resistor R is connected to the grounding wire; a first NOT gate F1 and a second NOT gate F2 located between the power line and the grounding wire, wherein an input of the first NOT gate F1 is connected to the second end of the capacitor C and the first end of the resistor R, an output of the first NOT gate F1 is used for outputting a first trigger signal, an input of the second NOT gate F2 is connected to the output of the first NOT gate F1, and an output of the second NOT gate F2 is used for outputting a second trigger signal. The ESD trigger circuit generating an ESD trigger signal when an ESD events occurs comprises steps of: generating a first trigger signal and a second trigger signal, transmitting the first and second trigger signals to each I/O unit, and transmitting the second trigger signal to the power clamp circuit.

Preferably, the power clamp circuit comprises a PMOS transistor, wherein a gate of the PMOS transistor is connected to the output of the second NOT gate F2 in the ESD trigger circuit, a drain of the PMOS transistor is connected to the power line, and a source of the PMOS transistor is connected to the grounding wire. The power clamp circuit forming a current discharge path from the power line to the ground line comprises steps of: a gate of the PMOS transistor in the power clamp circuit receiving the second trigger signal generated by the ESD trigger circuit and thus the PMOS transistor will be opened so as to form ESD discharge path from power to ground.

Preferably, the I/O unit comprises: a first PMOS transistor MP1, a first NMOS transistor MN1, a positive current path protection circuit, a negative current path protection circuit, a first logic control cell and a second logic control cell, wherein a gate of the first PMOS transistor MP1 is connected to the first logic control cell; a source of the first PMOS transistor MP1 is connected to the power line; a drain of the first PMOS transistor MP1 and a drain of the first NMOS transistor MN1 are jointly connected to an I/O pin; a gate of the first NMOS transistor MN1 is connected to the second logic control cell; a source of the first NMOS transistor MN1 is connected to the grounding wire; the first logic control cell is connected to the grounding wire as well as the output of the first NOT gate F1 and the output of the second NOT gate F2 in the ESD trigger circuit; and the second logic control cell is connected to the power line as well as the output of the first NOT gate F1 and the output of the second NOT gate F2 in the ESD trigger circuit. The I/O unit forming a current discharge path from the power line to the grounding wire comprises steps of: the first logic control cell opens the first PMOS transistor MP1; the second logic control cell opens the first NMOS transistor MN1 to form ESD discharge path from power to ground.

Preferably, the first logic control cell comprises: a second NMOS transistor MN2, a third NMOS transistor MN3, and a third PMOS transistor MP3, wherein a gate of the second NMOS transistor MN2 is connected to a gate of the third PMOS transistor MP3; a source of the second NMOS transistor MN2 is connected to the grounding wire; a drain of the second NMOS transistor MN2 is connected to the gate of the first PMOS transistor MP1; a gate of the third NMOS transistor MN3 is connected to the output of the first NOT gate F1; a source of the third NMOS transistor MN3 is connected to a source of the third PMOS transistor MP3 as well as the gate of the first PMOS transistor MP1; a drain of the third NMOS transistor MN3 is connected to a drain of the third PMOS transistor MP3; and a gate of the third PMOS transistor MP3 is connected to the output of the second NOT gate F2. The second logic control cell comprises: a second PMOS transistor MP2, a fourth NMOS transistor MN4, and a fourth PMOS transistor MP4;, wherein a gate of the second PMOS transistor MP2 is connected to a gate of the fourth NMOS transistor MN4; a source of the second PMOS transistor MP2 is connected to the power line; a drain of the second PMOS transistor MP2 is connected to the gate of the first NMOS transistor MN1; a gate of the fourth NMOS transistor MN4 is connected to the output of the first NOT gate F1; a source of the fourth NMOS transistor MN4 and the source of the fourth PMOS transistor MP4 are jointly connected to the gate of the first NMOS transistor MN1; a drain of the fourth NMOS transistor MN4 is connected to a drain of the fourth PMOS transistor MP4; and a gate of the fourth PMOS transistor MP4 is connected to the output of the second NOT gate F2. The first logic control cell opening the first PMOS transistor MP1 according to the first trigger signal and the second trigger signal in the ESD trigger circuit comprises steps of: closing the third NMOS transistor MN3 and the third PMOS transistor MP3, at the same time opening the second NMOS transistor MN2 and the first PMOS transistor MP1. The second logic control cell opens the first NMOS transistor MN1 through the mechanism of closing the fourth NMOS transistor MN4 and the fourth PMOS transistor MP4 at the same time opening the second PMOS transistor MP2 to open the first NMOS transistor MN1.

Preferably, the positive current path protection circuit comprises a first diode D1, a cathode of the first diode D1 being connected to the power line, and an anode of the first diode D1 being connected to the I/O pin. The negative, current path protection circuit comprises a second diode D2, a cathode of the second diode D2 being connected to the I/O pin, and an anode of the second diode D2 being connected to the grounding wire. When the ESD events occurs, an ESD current flows into the power line through the first diode D1 or second diode D2 in the positive current path protection circuit, and prompts the ESD trigger circuit to generate an ESD trigger signal.

The whole-chip ESD protection circuit of the present invention comprises ESD trigger circuits and power clamp circuits, which connect to multiple I/O units. When ESD occurs, the ESD trigger circuit generates an ESD trigger signal and transmits the ESD trigger signal to the power clamp circuit and each I/O unit so that the power clamp circuit and each I/O unit respectively forms a current discharge path from the power line to the grounding wire. Compared with the previous ESD protection approach in prior art, the whole-chip ESD protection circuit and method provided in the present invention employs an existing driving transistor in the I/O unit to realize efficient whole-chip ESD protection; that is, multiple evenly-distributed and effective ESD current discharge paths are formed in I/O units, thereby effectively improving the overall ESD protection capability. Hence, it is unnecessary to configure a power clamp circuit for each I/O unit in order to realize ESD protection, avoiding too many power clamp circuits configuration in the whole chip, hence reducing the overall size of the chip and lowering the cost.

### BRIEF DESCRIPTION OF THE DRAWINGS

FIG. 1 is a circuit structural diagram of distributed power clamp circuits employed in a chip in the prior art.

FIG. 2 is an overall effect diagram of a whole-chip ESD protection circuit consistent with the present invention in an implementation manner.

FIG. 3 is a principle block diagram of a whole-chip ESD protection circuit consistent with the present invention in an implementation manner.

FIG. 4 is a circuit structural diagram of the ESD trigger circuit and power clamp circuit in FIG. 3.

FIG. 5 is a principle block diagram of the I/O unit in FIG. 3.

FIG. 6 is a circuit structural diagram of FIG. 5 in a specific embodiment.

FIG. 7 shows sequence charts when ESD in FIG. 6 is effective and ineffective.

FIG. 8 is a schematic view of a current discharge path from a power line VDD to a grounding wire GND formed when ESD occurs.

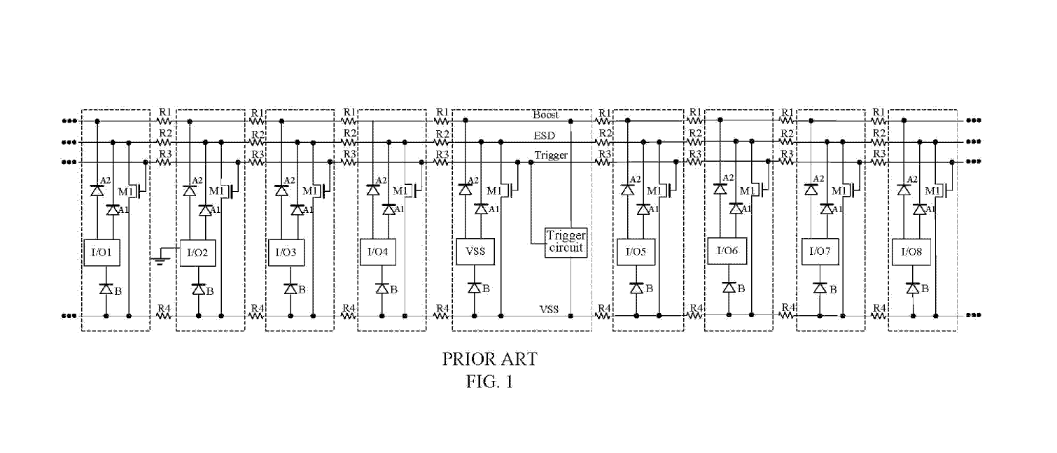

### DETAILED DESCRIPTION OF THE PREFERRED EMBODIMENTS

In the prior art, distributed power clamp circuits are used in the chip, and each I/O unit requires to be configured with a power clamp circuit; consequently, the overall size and the cost of the chip are significantly increased. Therefore, the inventor of the present invention has made improvement and proposes a whole-chip ESD protection circuit and protection method. The whole-chip ESD protection circuit includes: an ESD trigger circuit located between a power line and a grounding wire and connected to multiple I/O units, and a power clamp circuit located between the power line and the grounding wire and connected to the ESD trigger circuit. The whole-chip ESD protection method includes: providing an ESD protection device which includes an ESD trigger circuit and a power clamp circuit that are located between a power line and a grounding wire, and are connected to multiple I/O units, to prevent the I/O units from an ESD damage; and the ESD trigger circuit generating an ESD trigger signal when an ESD events occurs and transmits the ESD trigger signal to the power clamp circuit and each I/O unit so that the power clamp circuit and each I/O unit respectively forms a current discharge path from the power line to the grounding wire. Compared with the prior art; the whole-chip ESD protection circuit and protection method provided in the present invention could reduce the total number of power clamp circuits, thereby reducing the overall size of a chip and lowering the cost.

The implementation manner of the present invention is described in detail below through specific embodiments. A person skilled in the art can easily learn other advantages and efficacies of the present invention according to the content disclosed in the specification. The present invention may also be implemented or applied in other different specific implementation manners. Details in the specification may be modified or changed in various ways based on different points of views and applications without departing from the spirit of the present invention.

It should be noted that, the drawings provided in the implementation manner merely illustrate the fundamental idea of the present invention in a schematic way. Therefore, the drawings only show components related to the present invention rather than being drawn in accordance with the number, shape, and size of the components during actual implementation. The pattern, number, and ratio of the components during actual implementation may be changed randomly, and the layout pattern of the components may be more complex.

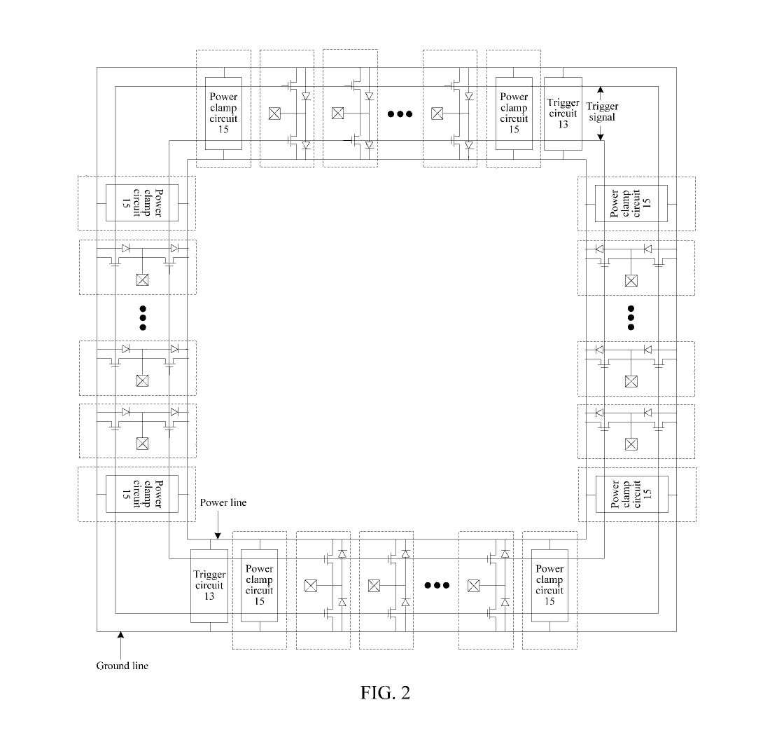

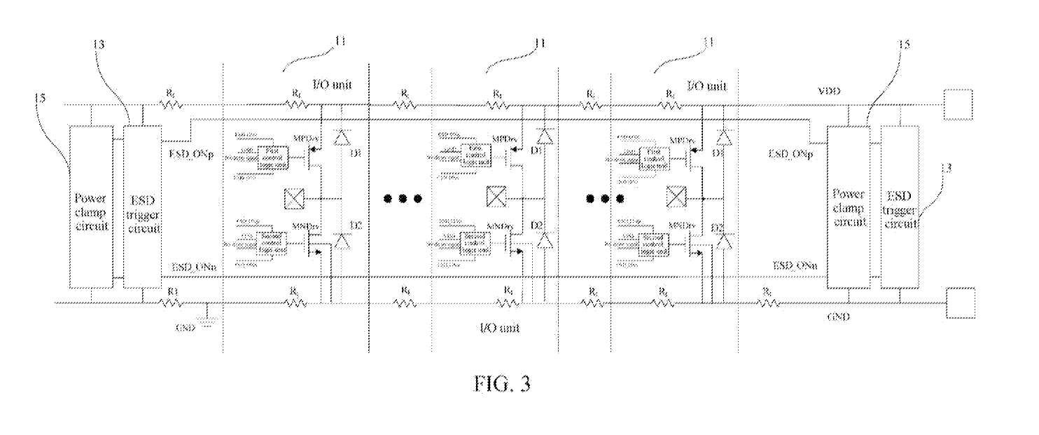

Referring to FIG. 2 and FIG. 3, FIG. 2 is an overall effect diagram of a whole-chip ESD protection circuit consistent with the present invention in an implementation manner, and FIG. 3 is a principle block diagram of a whole-chip ESD protection circuit consistent with the present invention in an implementation manner. As shown in FIG. 2 and FIG. 3, a whole-chip ESD protection circuit of the present invention includes: I/O units 11, an ESD trigger circuit 13, and a power clamp circuit 15. In FIG. 2, power bus of multiple I/O cells are connected to one power clamp circuit 15, and total of two ESD trigger circuits 13 are configured in the whole chip, which are located at opposite angles of the whole chip respectively.

The following describes each of the foregoing units in detail.

The I/O units 11 are located between the power line VDD and the grounding wire GND, and the I/O units are connected in parallel. In this implementation manner, each I/O unit is configured with a driving transistor.

The power clamp circuit 15 is located between the power line and the grounding wire, and is connected to the multiple I/O units 11. Particularly, in this embodiment, each power clamp circuit 15 is shared by multiple I/O units 11.

The ESD trigger circuit 13 is located between the power line and the grounding wire, and is connected to the I/O units 11 and the power clamp circuit 15.

In actual application, when an ESD event occurs in any one of the I/O units 11, the ESD trigger circuit 13 generates an ESD trigger signal and transmits the trigger signal to the power clamp circuit 15 and each I/O unit 11, so that the power clamp circuit 15 and each I/O unit 11 respectively forms a current discharge path from the power line VDD to the grounding wire GND. In this implementation manner, the ESD trigger signal generated by the ESD trigger circuit 13 includes a first trigger signal ESD_ONp and a second trigger signal ESD_ONn.

In addition, it should be noted that, in the above description, as shown in FIG. 2 and FIG. 3, the ESD trigger circuit 13 and the power clamp circuit 15 are two separate and independent devices, but the present invention is not limited thereto. In other embodiments, sometimes the ESD trigger circuit and the power clamp circuit are integrally disposed in the power module. Besides the power module, in practical applications, the ESD trigger circuit 13 in the present invention may also be disposed in any other modules in the chip, for example, the ESD trigger circuit 13 is disposed in a filler cell.

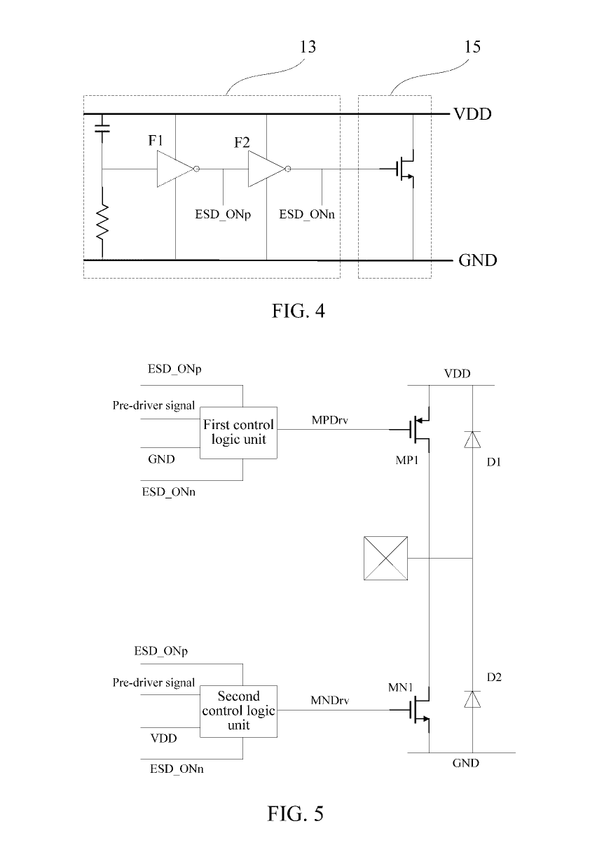

Referring to FIG. 4, FIG. 4 shows a circuit structural diagram of the ESD trigger circuit 13 and the power clamp circuit 15 in FIG. 3. Referring to FIG. 3 and FIG. 4 in combination, the ESD trigger circuit includes: a resistor-capacitor circuit connected in series between the power line VDD and the grounding wire GND, wherein a first end of the capacitor C is connected to the power line VDD, a second end of the capacitor C is connected to a first end of the resistor R, and a second end of the resistor R is connected to the grounding wire GND; and a first NOT gate F1 and a second NOT gate F2 between the power line VDD and the grounding wire GND, wherein an input of the first NOT gate F1 is connected to the second end of the capacitor C and the first end of the resistor R, an output of the first NOT gate F1 is used for outputting a first trigger signal ESD_ONp, an input of the second NOT gate F2 is connected to the output of the first NOT gate F1, and an output of the second NOT gate F2 is used for outputting a second trigger signal ESD_ONn. In addition, the power clamp circuit 15 includes a PMOS transistor, a gate thereof being connected to the output of the second NOT gate F2 in the ESD trigger circuit 13 and used for receiving the second trigger signal ESD_ONn a drain thereof being connected to the power line VDD, and a source thereof being connected to the grounding wire GND. In a normal working state, the first trigger signal ESD_ONp is at a high level, the second trigger signal ESD_ONn is at a low level, and the power clamp circuit 15 does not conduct. When ESD events occurs, due to the coupling and delay effects of the RC, the first trigger signal ESD_ONp turns to be at a low level while the second trigger signal ESD_ONn turns to be at a high level, and the power clamp circuit 15 conducts and discharges current; the first trigger signal ESD_ONp and the second trigger signal ESD_ONn are also transmitted to each I/O unit 11.

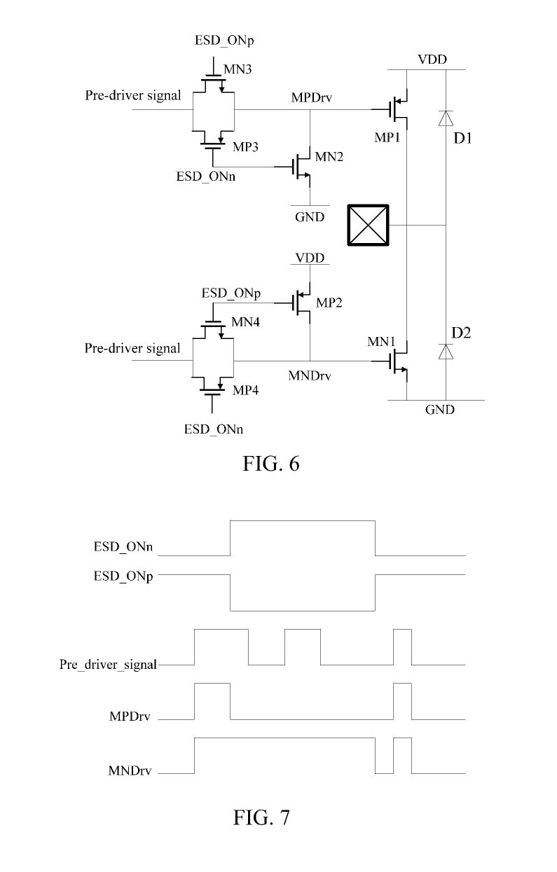

Further referring to FIG. 5 and FIG. 6, FIG. 5 is a principle block diagram of the I/O unit 11 in FIG. 3 in an implementation manner, and FIG. 6 is a circuit structural diagram of FIG. 5 in a specific embodiment. As shown in FIG. 5, each I/O unit 11 includes: a first PMOS transistor MP1, a first NMOS transistor MN1, a positive current path protection circuit, a negative current path protection circuit, a first logic control cell, and a second logic control cell. A gate of the first PMOS transistor MP1 is connected to the first logic control cell and used for receiving a first driver signal MPDrv. A source of the first PMOS transistor MP1 is connected to the power line VDD. A drain of the first PMOS transistor MP1 and a gate of the first NMOS transistor MN1 are connected to an I/O pin. The gate of the first NMOS transistor MN1 is connected to the second logic control cell and used for receiving a second driver signal MNDrv. A source of the first NMOS transistor MN1 is connected to the grounding wire GND. The first logic control cell is connected to the grounding wire GND. The output of the first NOT gate F1 in the ESD trigger circuit is connected to the output of the second NOT gate F2. The second logic control cell is connected to the power line VDD. The output of the first NOT gate F1 in the ESD trigger circuit is connected to the output of the second NOT gate F2. The positive current path protection circuit includes a first diode D1, a cathode of the first diode D1 being connected to the power line VDD, and an anode of the first diode D1 being connected to the I/O pin. The negative current path protection circuit includes a second diode D2, a cathode of the second diode D2 being connected to the I/O pin, and an anode of the second diode D2 being connected to the grounding wire GND. Furthermore, as shown in FIG. 6, the first logic control cell further includes: a second NMOS transistor MN2, a third NMOS transistor MN3, and a third PMOS transistor MP3. A gate of the second NMOS transistor MN2 is connected to a gate of the third PMOS transistor MP3. A source of the second NMOS transistor MN2 is connected to the grounding wire GND. A drain of the second NMOS transistor MN2 is connected to the gate of the first PMOS transistor MN1. A gate of the third NMOS transistor MN3 is connected to the output of the first NOT gate F1 so as to receive the first trigger signal ESD_ONp. A source of the third NMOS transistor MN3 is connected to a source of the third PMOS transistor MP3 and the gate of the first PMOS transistor MP1. A drain of the third NMOS transistor MN3 is connected to a drain of the third PMOS transistor MP3 so as to receive a pre-driver signal Pre_driver_signal of a previous I/O unit. A gate of the third PMOS transistor MP3 is connected to the output of the second NOT gate F2 so as to receive the second trigger signal ESD_ONn. The second logic control cell further includes: a second PMOS transistor MP2, a fourth NMOS transistor MN4, and a fourth PMOS transistor MP4. The gate of the second PMOS transistor. MP2 is connected to the gate of the fourth NMOS transistor MN4. The source of the second PMOS transistor MP2 is connected to the power line VDD. The drain of the second PMOS transistor MP2 is connected to the gate of the first NMOS transistor MN1. The gate of the fourth NMOS transistor MN4 is connected to the output of the first NOT gate F1 so as to receive the first trigger signal ESD_ONp. The source of the fourth NMOS transistor MN4 is connected to the source of the fourth PMOS transistor MP4 and the gate of the first NMOS transistor MN1. The drain of the fourth NMOS transistor MN4 is connected to the drain of the fourth PMOS transistor MP4 so as to receive the pre-driver signal Pre_driver_signal of the previous I/O unit. The gate of the fourth PMOS transistor MP4 is connected to the output of the second NOT gate F2 so as to receive the second trigger signal ESD_ONn.

The effect of the whole-chip ESD protection circuit in the actual application is described with the reference to FIG. 3, FIG. 4, and FIG. 6 in combination.

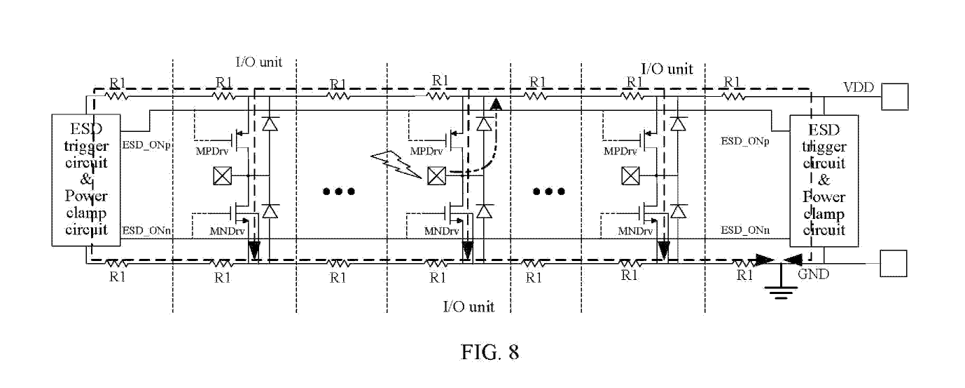

The first trigger signal ESD ONp and the second trigger signal ESD_ONn in FIG. 6 may be acquired from the ESD trigger circuit 13 in FIG. 4. In a normal working state (as shown in FIG. 7), the first trigger signal ESD_ONp is at a high level; the second trigger signal ESD_ONn is at a low level; the second NMOS transistor MN2 and second PMOS transistor MP2 do not conduct; the third NMOS transistor MN3, the third PMOS transistor MP3, the fourth NMOS transistor MN4, and the fourth PMOS transistor MP4 all conduct; the pre-driver signal Pre_driver_signal, can be normally transmitted to the first PMOS transistor MP1 and first NMOS transistor MN1 which are working as driving transistors. When ESD events occurs (as shown in FIG. 7), the first trigger signal ESD_ONp turns to be at a low level while the second trigger signal ESD_ONn turns to be at a high level; the third NMOS transistor MN3, the third PMOS transistor MP3, the fourth NMOS transistor MN4, and the fourth PMOS transistor MP4 do not conduct; the second NMOS transistor MN2 and the second PMOS transistor MP2 conduct; the first PMOS transistor MP1 and the first NMOS transistor MN1 are simultaneously turned on, thereby forming a current discharge path from the power line VDD to the grounding wire GND. Seen as a whole, as shown in FIG. 8, when an ESD events occurs, for example, an ESD events occurs between certain I/O pin and the power, the current flows from the I/O pin to the power line VDD through, a diode that conducts in a positive current direction. Subsequently, the ESD trigger circuit generates an ESD trigger signal and transmits the ESD trigger signal to the power clamp circuit and each I/O unit, driving the power clamp circuit and the driving transistors in each I/O unit (the first PMOS transistor MP1 and first NMOS transistor MN1) to be turned on, so that the power clamp circuit and each I/O unit form a current discharge path from the power line VDD to the grounding wire GND. The dashed-line arrow in FIG. 8 represents the discharge flow direction of the ESD current in the entire circuit.

In sum, in the whole-chip ESD protection circuit and ESD protection method provided in the present invention, the whole-chip ESD protection circuit includes an ESD trigger circuit and a power clamp circuit connected to multiple I/O units; when ESD occurs, the ESD trigger circuit generates an ESD trigger signal and transmits the ESD trigger signal to the power clamp circuit and each I/O unit so that the power clamp circuit and each I/O unit form a current discharge path from the power line to the grounding wire respectively. Compared with the prior art, the whole-chip ESD protection circuit and the ESD protection method provided in the present invention utilize an existing driving transistor in the I/O unit to realize efficient whole-chip ESD protection; that is, an effective ESD current discharge path is formed in each I/O unit, and each path is evenly distributed, thereby effectively improving the overall ESD protection capability of a chip. Hence, it is unnecessary to configure a power clamp circuit for each I/O unit with regard to the ESD, avoiding adding too many power clamp circuits in the whole chip, hence reducing the overall size of the chip and lowering the cost.

The above description of the detailed embodiments is only to illustrate the principle and efficacy of the present invention, and is not intended to limit the present invention. A person skilled in the art could make modifications to the above embodiments without departing from the spirit and scope of the present invention. Therefore, the scope of the present invention is subject to the appended claims.

What is claimed is:

1. A whole-chip ESD protection circuit, comprising:
I/O units located between a power line and a grounding wire;
a power clamp circuit located between the power line and the grounding wire and connected to the I/O units. each power clamp circuit being shared by multiple I/O units; and
an ESD trigger circuit located between the power line and the grounding wire, wherein the ESD trigger circuit generates an ESD trigger signal when an ESD events occurs and transmits the ESD trigger signal to the power clamp circuit and each I/O unit so that the power clamp circuit and each I/O unit respectively forms a current discharge path from the power line to the grounding wire.

2. The whole-chip ESD protection circuit as in claim 1, wherein the ESD trigger circuit comprises:
a resistor-capacitor circuit connected in series between the power line and the grounding wire, wherein a first end of the capacitor C is connected to the power line, a second end of the capacitor C is connected to a first end of the resistor R, and a second end of the resistor R is connected to the grounding wire; and
a first NOT gate F1 and a second NOT gate F2 located between the power line and the grounding wire, wherein an input of the first NOT gate F1 is connected to the second end of the capacitor C and the first end of the resistor R, an output of the first NOT gate F1 is used for outputting a first trigger signal, an input of the second NOT gate F2 is connected to the output of the first NOT gate F1. and an output of the second NOT gate F2 is used for outputting a second trigger signal.

3. The whole-chip ESD protection circuit as in claim 2, wherein the power clamp circuit comprises a PMOS transistor, wherein a gate of the PMOS transistor is connected to the output of the second NOT gate F2 in the ESD trigger circuit, a drain of the PMOS transistor is connected to the power line, and a source of the PMOS transistor is connected to the grounding wire.

4. The whole-chip ESD protection circuit as in claim 2, wherein the I/O unit comprises: a first PMOS transistor MP1, a first NMOS transistor MN1, a positive current, path protection circuit, a negative current path protection circuit, a first logic control cell, and a second logic control cell, wherein a gate of the first PMOS transistor MP1 is connected to the first logic control cell; a source of the first PMOS transistor MP1 is connected to the power line; a drain of the first PMOS transistor MP1 and a drain of the first NMOS transistor MN1 are jointly connected to an I/O pin; a gate of the first NMOS transistor MN1 is connected to the second logic control cell; a source of the first NMOS transistor MN1 is connected to the grounding wire; the first logic control cell is connected to the grounding wire as well as, the output of the first NOT gate F1 and the output of the second NOT gate F2 in the ESD trigger circuit; and the second logic control cell is connected to the power line as well as the output of the first NOT gate F1 and the output of the second NOT gate F2 in the ESD trigger circuit.

5. The whole-chip ESD protection circuit as in claim 4, wherein
the first logic control cell comprises: a second NMOS transistor MN2, a third NMOS transistor MN3, and a third PMOS transistor MP3, wherein a gate of the second NMOS transistor MN2 is connected to a gate of the third PMOS transistor MP3; a source of the second NMOS transistor MN2 is connected to the grounding wire; a drain of the second NMOS transistor MN2 is connected to the gate of the first PMOS transistor MP1; a gate of the third NMOS transistor MN3 is connected to the output of the first NOT gate F1; a source of the third NMOS transistor MN3 and a source of the third PMOS transistor MP3 are jointly connected to the gate of the first PMOS transistor MP1; a drain of the third NMOS transistor MN3 is connected to a drain of the third PMOS transistor MP3; and a gate of the third PMOS transistor MP3 is connected to the output of the second NOT gate F2; and
the second logic control cell comprises: a second PMOS transistor MP2, a fourth NMOS transistor MN4, and a fourth PMOS transistor MP4, wherein a gate of the second PMOS transistor MP2 is connected to a gate of the fourth NMOS transistor MN4; a source of the second PMOS transistor MP2 is connected to the power line; a drain of the second PMOS transistor MP2 is connected to the gate of the first NMOS transistor MN1; a gate of the fourth NMOS transistor MN4 is connected to the output of the, first NOT gate F1; a source of the fourth NMOS transistor MN4 and the source of the fourth PMOS transistor MN are jointly connected to the gate of the first NMOS transistor MN1; a drain of the fourth NMOS transistor MN4 is connected to a drain of the fourth PMOS transistor MP4; and a gate of the fourth PMOS transistor MP4 is connected to the output of the second NOT gate F2.

6. The whole-chip ESD protection circuit as in claim 4, wherein the positive current path protection circuit comprises a first diode D1, a cathode of the first diode D1 being connected to the power line, and an anode of the first diode D1 being connected to the I/O pin; the negative current path protection circuit comprises a second diode D2, a cathode of the second diode D2 being connected to the I/O pin, and another anode of the second diode D2 being connected to the grounding wire.

7. The whole-chip ESD protection circuit as in claim 1, wherein the ESD trigger circuit and the power clamp circuit are disposed in a power module of a chip, or the LSD trigger circuit is disposed in a filler cell of the chip.

8. A whole-chip ESD protection method, comprising steps of:
providing an ESD protection device between a power line and a grounding wire, wherein the ESD protection device comprises: I O units located between a power line and a grounding wire; a power clamp circuit located between the power line and the grounding wire and connected to the I/O units, each power clamp circuit being shared by multiple I/O units; and an ESD trigger circuit located between the power line and the grounding wire; and
protecting the I/O unit from ESD damage, comprising steps of: the ESD trigger circuit generating an ESD trigger signal when an ESD events occurs and transmitting the ESD trigger signal to the power clamp circuit and each I/O unit so that the power clamp circuit and each I/O unit respectively forms a current discharge path from the power line to the grounding wire.

9. The whole-chip ESD protection method as in claim 8, wherein:
the ESD trigger circuit comprises: a resistor-capacitor circuit connected in series between the power line and the grounding wire, wherein a first end of the capacitor C; is connected to the power line, a second end of the capacitor C is connected to a first end of the resistor R, and a second end of the resistor R is connected to the grounding wire; a first NOT gate F1 and a second NOT gate F2 located between the power line and the grounding wire, wherein an input of the first NOT gate F1 is connected to the second end of the capacitor C and the first end of the resistor R, an output of the first NOT gate F1 is used for outputting a first trigger signal, an input of the second NOT gate F2 is connected to the output of the first NOT gate F1, and an output of the second NOT gate F2 is used for outputting a second trigger signal; and
the ESD trigger circuit generating an ESD trigger signal when an ESD events occurs comprises steps of: generating a first trigger signal and a second trigger signal, transmitting the first and second trigger signals to each I/O unit, and transmitting the second trigger signal to the power clamp circuit.

10. The whole-chip ESD protection method as in claim 9, wherein:
the power clamp circuit comprises a PMOS transistor, wherein a gate of the PMOS transistor is connected to the output of the second NOT gate F2 in the ESD trigger circuit, a drain of the PMOS transistor is connected to the power line, and a source of the PMOS transistor is connected to the grounding wire; and
the power clamp circuit forming a current discharge path from the power line to the ground line comprises steps of a gate of the PMOS transistor in the power clamp circuit receiving the second trigger signal generated by the ESD trigger circuit and thus the PMOS transistor conducting so as to form the current discharge path from the power line to the grounding wire.

11. The whole-chip ESD protection method as in claim 9, wherein
the I/O unit comprises: a first PMOS transistor MP1, a first NMOS transistor MN1, a positive current path protection circuit, a negative current path protection circuit, a first logic control cell, and a second logic control cell, wherein a gate of the first PMOS transistor MP1 is connected to the first logic control cell; a source of the first PMOS transistor WI is connected to the power line; a drain of the first PMOS transistor MP1 and a drain of the first NMOS transistor MN1 are jointly connected to an I/O pin; a gate of the first NMOS transistor MN1 is connected to the second logic control cell; a source of the first NMOS transistor MN1 is connected to the grounding wire; the first logic control cell is connected to the grounding wire as well as the output of the first NOT gate F1 and the output of the second NOT gate F2 in the ESD trigger circuit; and the second logic control cell is connected to the power line as well as the output of the first NOT gate F1 and the output of the second NOT gate F2 in the ESD trigger circuit; and
the I/O unit forming a current discharge path from the power line to the grounding wire comprises steps of: the first logic control cell opens the first PMOS transistor MP1 according to the first trigger signal and the second trigger signal in the ESD trigger circuit; and the second logic control cell opens the first NMOS transistor MN1 according to the first trigger signal and the second trigger signal in the ESD trigger circuit to form ESD discharge path from power to ground.

12. The whole-chip ESD protection method as in claim 11, wherein
the first logic control cell comprises: a second NMOS transistor MN2, a third NMOS transistor MN3, and a third PMOS transistor MP3, wherein a gate of the second NMOS transistor MN2 is connected to a gate of the third PMOS transistor MP3; a source of the second NMOS transistor MN2 is connected to the grounding wire; a drain of the second NMOS transistor MN2 is connected to the gate of the first PMOS transistor MP1; a gate of the third NMOS transistor MN3 is connected to the output of the first NOT gate F1; a source of the third NMOS transistor MN3 and a source of the third PMOS transistor MP3 are jointly connected to the gate of the first PMOS transistor MP1; a drain of the third NMOS transistor MN3 is connected to a drain of the third PMOS transistor MP3; and a gate of the third PMOS transistor MP3 is connected to the output of the second NOT gate F2;
the second logic control cell comprises: a second PMOS transistor MP2, a fourth NMOS transistor MN4, and a fourth PMOS transistor MP4, wherein a gate of the second PMOS transistor MP2 is connected to a gate of the fourth NMOS transistor MN4; a source of the second PMOS transistor MP2 is connected to the power line; a drain of the second PMOS transistor MP2 is connected to the gate of the first NMOS transistor MN1; a gate of the fourth NMOS transistor MN4 is connected to the output of the first NOT gate F1; a source of the fourth NMOS transistor MN4 and the source of the fourth PMOS transistor MP4 are jointly connected to the gate of the first NMOS transistor MN1; a drain of the fourth NMOS transistor MN4 is connected to a drain of the fourth PMOS transistor MP4; and a gate of the fourth PMOS transistor MP4 is connected to the output of the second NOT gate F2;
the first logic control cell opening the first PMOS transistor MP1 according to the first trigger signal and the second trigger signal in the ESD trigger circuit comprises steps of: closing the third NMOS transistor MN3 and the third PMOS transistor MP3, at the same time opening the second NMOS transistor MN2 and the first PMOS transistor MP1; and
the second logic control cell opening the first NMOS transistor MN1 according to the first trigger signal and the second trigger signal in the ESD trigger circuit comprises steps of: closing the fourth NMOS transistor MN4 and the fourth PMOS transistor MP4, at the same time opening the second PMOS transistor MP2 and the first NMOS transistor MN1.

13. The whole-chip ESD protection method as in claim 11, wherein
the positive current path protection circuit comprises a first diode D1, a cathode of the first diode D1 being connected to the power line, and an anode of the first diode D1 being connected to the I/O pin; the negative current path protection circuit comprises a second diode D2, a cathode of the second diode D2 being connected to the I/O pin, and an anode of the second diode D2 being connected to the grounding wire; and
when the ESD events occurs, an ESD current flows into the power line through the first diode D1 or second diode D2 in the positive current path protection circuit, and prompts the ESD trigger circuit to generate an ESD trigger signal.
